(19) United States
(12) Patent Application Publication
(10) Pub. No.: US 2007/0160176 A1
(43) Pub. Date: Jul. 12, 2007

(54) Isotope generator

(76) Inventor: Ryoichi Wada, College Station, TX (US)

Correspondence Address: EDWIN TARVER, 16830 Ventura Blvd., SUITE 360, Encino, CA, 91436, US

(21) Appl. No.: 11/326,747

(22) Filed: Jan. 6, 2006

(51) Int. Cl. G21G 1/06

(52) U.S. Cl. 376/158

(57) ABSTRACT

An isotope generator comprising a first container for hosting a neutron source, and a second container for containing a sample, arranged in the proximity of the first container, for receiving and exposing the sample to the neutrons received from a neutron source, enabling isotope generation. The first and second containers disposed and suspended in an environment capable of absorbing neutrons from the environment and reducing their energy. An (n,2n) reaction takes place in the generator and produces an isotope, either as a direct output, as a daughter isotope or as an intermediate product that further emits an electron (beta ray) to produce the final daughter isotope.

### CROSS-REFERENCE TO RELATED APPLICATIONS:

None

### FEDERALLY SPONSORED RESEARCH:

Not Applicable

### SEQUENCE LISTING:

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF INVENTION

This invention generally relates to isotope generator, more specifically to a system and method for isotope generation, and still more precisely to a system and method of positron emitting isotope generator.

### BACKGROUND

Atoms, which comprise all matter, consist of protons, neutrons and electrons in an electrically balance configuration. The atomic mass of an atom is determined by the sum of protons and neutrons, and the chemical nature of a particular element is determined by the number of electrons taking part in a given chemical reaction.

It has been observed that some atoms, while having the same number of electrons and protons, have a different number of neutrons. These atoms have the same chemical properties of the element, but have different atomic masses. These atoms are called isotopes. In nature, isotopes are distributed along a line called the beta stability line, which is empirically given by the following equation;
Z=A/(2.02+0.015A^{2/3})
Here Z and A represent atomic number and atomic mass, respectively.

Besides natural availability, isotopes can be produced artificially as well. Artificially produced isotopes are unstable, and by emitting an electron, positron and/or a gamma ray they decay into another stable isotope of the element; called a daughter isotope. These unstable isotopes are also called radioactive isotopes or radioisotopes hereinafter interchangeably referred to as isotopes. All radioactive or unstable isotopes are characterized by their half life, which is defined as the time it takes for half of the total number of radioisotopes to decay into daughter isotopes. These artificially produced isotopes are more widely distributed along the beta stability line than natural isotopes.

There are numerous applications for radioisotopes; including uses in nuclear medicine and other industries. In nuclear medicine, radioisotopes can be used both diagnostically, and for radiation therapy. When using these isotopes in medical applications, a short half life is typically necessary to minimize unnecessary radiation exposure to patients. Technetium, which has a short half life, is the most widely used radioisotope because of its natural tendency to emit gamma rays, along with low energy beta rays. Beta emitters are used for radiotherapy because they destroy malfunctioning cells, but are easily stopped by the surrounding tissue.

Positron emission therapy (PET) is also useful as a diagnostic tool in nuclear medicine. A positron emitter attached to a substrate is injected into a patient. Some of the substrate is absorbed by actively growing tumors. The radioisotope then emits positrons which immediately combine with nearby electrons to decay into two gamma rays, emitted in opposite directions. By detecting these gamma rays and measuring the difference in their arrival time from the location of the emitter, the location of a tumor and a corresponding image of the tumor can be obtained.

In industry, radioisotopes are used for gamma radiography and gauging. Gamma radiography is similar to x-ray radiography, but since gamma rays have higher penetrability, this is an effective inspection technique for internal defects of materials; detecting explosives and fissile material in cargo or luggage, for oil wells, logging industry etc. Beta radioisotopes are used to detect the presence or absence of materials. The quantity or density of materials can also be determined from a distance, without contacting the gauged material.

There are two methods for producing radioisotopes; nuclear reactors and cyclotrons. Neutrons generated in nuclear reactors are low energy neutrons called thermal neutrons, and are created through the process of fission. These neutrons are easily captured by an isotope according to the following equation:
Eᵢ(Z,A)+n------------>E_{f}(Z,A+1),
In this equation radioisotopes are generated by the absorption of neutrons by an element E. Where n is a neutron, Eᵢ(Z,A) is parent isotope with atomic number Z represented as first variable in bracket, and atomic mass A represented as second variable in the bracket, whereas E_{f}(Z,A+1) is the radioisotope produced with the atomic number Z and atomic mass A+1. In this method, isotopes are produced by adding one neutron in the parent isotope. The newly produced daughter isotope lies on the neutron-rich side of the beta stability line and decays toward the stability line by emitting electrons and gamma rays.

In cyclotrons, radioisotopes are produced mainly by the (p,n) reaction:
Eᵢ(Z,A)+p------------>E_{f}(Z+1,A)+n,
In this method, the absorption of a proton and the emission of a neutron take place. Here, p is a proton and E_{f}(Z+1,A) is the radioisotope produced, having atomic number Z+1. However, atomic mass A remains the same, since the initial isotope loses a neutron. Isotopes produced in this way are distributed along the proton-rich side of the beta stability line. These isotopes decay toward the stability line by emitting a positron and/or gamma rays.

Small neutron generators to create these radioisotopes are already available. In the process of producing radioisotopes, the neutron participating in the reaction must have an energy level higher than the reaction threshold, which is generally between 7-14 MeV for most stable isotopes. In order to generate such high energy neutrons, neutron generators use the following fusion reaction:
D+T---->⁴He+n(Eₙ=14MeV),
D, T and ⁴He are deuteron, triton and helium respectively. Eₙ is the energy of the emitted neutron. Another important requirement is the intensity of generated neutron. The neutron generator must produce a sufficient number of neutrons per second to produce radioisotopes for practical use.

Radioisotopes used in medicine have a short half life, so these isotopes must be made as needed in a hospital setting. Moreover, a nuclear reactor or cyclotron requires a large infrastructure. It is not possible for small hospitals to install a cyclotron or nuclear reactor to produce radioisotopes as they are required. U.S. patent application publication number US 2005/0082469 discusses a method in which a material is exposed to a neutron flux by distributing it in a neutron-diffusing medium surrounding a neutron source. The diffusing medium is transparent to neutrons and so arranged that neutron scattering substantially enhances the neutron flux to which the material is exposed. Such enhanced neutron exposure may be used to produce useful radioisotopes, in particular for medical applications, from the transmutation of readily-available isotopes included in the exposed material. It may also be used to efficiently transmute long-lived radioactive wastes, such as those recovered from spent nuclear fuel. The use of heavy elements, such as lead and/or bismuth, as the diffusing medium is particularly of interest, since it results in a slowly decreasing scan through the neutron energy spectrum, thereby permitting very efficient resonant neutron capture in the exposed material. According to this neutron generation method, a radioactive source or accelerator is used instead of a nuclear reactor. Neutrons emitted from the source go through a highly diffusive material to lower the energy to an appropriate value for maximizing neutron capture with minimum neutron loss. This isotope is further surrounded by additional diffusive material to enhance the neutron capture probability. Since these isotopes are produced by capturing a thermal neutron, and products distribute on the neutron-rich side of the beta stability line, no positron emitter isotopes can be produced using this method.

Therefore it is an object of the present invention to provide an isotopes producing device.

It is another object of the present invention to provide a system and method for producing isotopes.

Yet another object of the present invention is to provide a small device to produce isotopes.

Yet still another object of the present invention is to provide a method for producing short half life isotope.

Still yet another object of the present invention is to provide a device and method for producing isotopes on site.

It is an additional object of the present invention to provide a device capable of producing positron emitting isotopes.

### SUMMARY

To achieve these and other objects, the present invention provides a method and compact system to produce positron emitting and short half life isotopes on-site that can be directly used in situations where positron emitting isotopes are required.

An isotope generator comprising a first container, hereinafter referred to as a neutron generator vessel, for hosting a neutron source, hereinafter referred to as an internal neutron generator, is disclosed. A second container containing a parent isotope sample is arranged in the proximity of the neutron generator vessel for receiving and exposing the sample to the neutrons received from the neutron source, thereby enabling isotope generation. The neutron generator vessel and internal neutron generator are suspended in an environment capable of absorbing neutrons, hereinafter referred to as a neutron absorber. In this generator, the (n,2n) reaction takes place and produces an isotope. Isotopes produced by the generator comprise either direct output, as a daughter isotope, or an intermediate product that further emits an electron (beta ray) to produce final daughter isotope.

To create the isotope generator, any available neutron generator can be used. However, it is a basic requirement that the energy of generated neutrons must be higher than the reaction threshold of a sample. The neutron generator must therefore be compact with a sufficiently high intensity neutron beam or neutron flux. The neutron beam, or flux, is the rate of flow of neutrons passing through a unit area in a given time. The neutron generator of the isotope generator is housed in a vessel made of aluminum and/or an insulating material like glass or ceramic to control neutron activation. The second container, containing the parent isotope, surrounds neutron generator vessel. This second container surrounds the neutron generator vessel closely and is made of thin walls of a light material such as aluminum and/or an insulating material like glass or ceramic that does not contain hydrogen, for maximizing the excitation of the parent isotope. The second container may be provided with one or more chambers for containing one or more samples.

The neutrons generated by the neutron source are generally high energy, and when they react with a parent isotope, they release more than one neutron. Therefore excessive neutrons are captured by this device to prevent neutrons leaking outside the system. To address this problem, the assembly of the first and second container is suspended in a neutron absorbing material. This neutron absorbing material comprises a hydrogen rich material such as water, paraffin, plastic, or any other material which exhibits high neutron absorption characteristics; including Boron or Gadolinium compounds. The neutron absorber reduces the energy of neutron flux quickly and captures the neutrons in the material itself. Furthermore, the neutron generator is encased in a gamma ray shield; a thick wall made of heavy metal to prevent gamma rays produced during the process from leaking to the outside of the system. The complete assembly of a first and second container, neutron absorber, and gamma ray shield are surrounded by an outer metal box that further comprises an opening and closing mechanism, and a door for allowing access into the isotope generator.

The isotope generator produces isotopes using the (n,2n) reaction in which sample isotopes react with high energy neutron flux having an energy higher than the reaction threshold of the sample. The reaction takes place in the following way: Neutron flux is generated from the neutron source by exposing the sample to generated neutron flux, and starting the reaction in the sample, liberating more than one neutron from the sample through the reaction, producing another isotope, and either receiving this generated isotope as a final daughter isotope from the generator, or upon the further radiation of a beta ray from the isotope received from reaction, producing a final daughter isotope.

### DETAILED DESCRIPTION

The following description details the preferred embodiments of the invention. However, the embodiments used for describing the invention are illustrative only and in no way limit the scope of the invention. A person skilled in the art will appreciate that many more embodiments of the invention are possible without deviating from the basic concept of the invention.

An isotope generator comprising a first container that contains a neutron generator source for hosting a neutron source, and a second container for containing a parent isotope, arranged in proximity of said first container source for receiving and exposing said sample to the neutrons received from said neutron, and for enabling isotope generation, said first and second containers being suspended in an environment capable of absorbing neutrons in said environment and reducing their energy.

This invention proposes methods to transform a stable isotope in a sample to a radioactive isotope through the (n,2n) reaction. The isotopes produced by the generator are produced either as direct output of the reaction or through an intermediate product that further emits an electron (beta ray) to produce the final isotope. In one preferred embodiment, the reaction that takes place in the isotope generator can be represented by the following equation:
Eᵢ(Z,A)+n------------>E_{f}(Z,A−1)+2n (n,2n reaction)

In the above equation, an isotope is generated by the reaction of a neutron and an element E, where, n is a neutron, Eᵢ(Z,A) is parent isotope with atomic number Z and atomic mass A, whereas E_{f}(Z,A−1) is an isotope produced with atomic number Z and atomic mass A−1.

In this embodiment a compound ¹⁸F-FDG (¹⁸F-labelled Fluorodeoxyglucose) is used; currently a widely used material for diagnosis in nuclear medicine, positron emission therapy (PET) scans, and imaging. In the second container, a sample of non-activated FDG is placed prior to use. During the reaction process, this FDG is partially transformed into ¹⁸F-FDG. The amount of radioactivity of the produced ¹⁸F-FDG is a function of the intensity of the neutron flux from neutron generator and the duration of activation. Therefore, by using this simple, compact device, a positron emitting isotope is generated on site as needed, and can be easily made wherever it is required.

Another method of producing isotopes with this invention uses an (n,2n) reaction for producing an intermediate isotope. Upon further beta decay, this isotope produces the final product according to the following reaction:
Eᵢ(Z,A)+n------------>E_{f}*(Z,A−1)+2n (n,2n reaction)
E_{f}*(Z,A−1)------------>E_{f}(Z−1,A−1)+e− (Beta decay)

In the above equation an intermediate isotope is generated through a reaction with a neutron by element E. Here, n represents a neutron, Eᵢ(Z,A) is parent isotope with atomic number Z and atomic mass A; whereas E_{f}*(Z,A−1) is an intermediate isotope with atomic number Z and atomic mass A−1. This intermediate isotope produces the final isotope E_{f}(Z−1,A−1) having an atomic number Z−1 and atomic mass A−1 upon beta decay.
¹⁰⁰Mo+n------------------------>⁹⁹Mo+2n (intermediate product)
⁹⁹Mo----------->^{99m}Tc (Beta decay)

In this embodiment, ^{99m}Tc (Technetium 99 in a meta-stable state) is produced using ¹⁰⁰Mo (Molybdenum 100) as a sample or parent isotope. During (n,2n) reaction this ¹⁰⁰Mo changes into ⁹⁹Mo, another isotope of Molybdenum. This newly produced intermediate ⁹⁹Mo isotope produces ^{99m}Tc by beta decay which is the final daughter isotope capable of positron emission.

### BRIEF DESCRIPTION OF THE DRAWINGS

FIG. 1 shows neutron oven for producing radioisotopes.

FIG. 2 Energy threshold graph for (n,2n) reaction for stable isotopes.

### Reference Numerals

1 . . . Internal Neutron Generator/Neutron Source
2 . . . Neutron Generator Vessel/First Container
3 . . . Second Container
4 . . . Neutron Absorber
5 . . . Heavy Metal Gamma Ray Absorber
6 . . . Outer Metal Box
7 . . . Wheels for Opening the Oven

### DETAILED DESCRIPTION OF THE DRAWINGS

A further understanding of the present invention may be obtained with reference to the following description taken in conjunction with the accompanying drawings. However, the embodiments used for describing the invention are illustrative only and in no way limits the scope of the invention. A person skilled in the art will appreciate that many more embodiments of the invention are possible without deviating from the basic concept of the invention. Any such embodiment will fall under the scope of the invention and is a subject matter of protection.

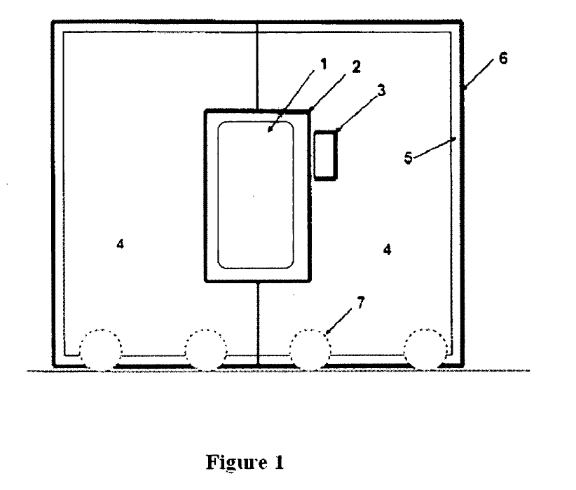

FIG. 1 illustrates the isotope generator, a first container 2, where a neutron source 1 is kept, and in which neutrons of particular energy are generated. This first container is made of aluminum or another insulating metal to minimize activation. The second container 3 contains a sample, arranged in proximity to the first container 2 for receiving and exposing the sample to neutrons received from the neutron source 1. The second container 3 is also made of aluminum or another insulating metal and its capacity can be varied depending upon the sample amount needed at a given time. The thickness of the walls between the neutron source and the sample of second container 3 is minimized to maximize the efficiency of the system. To enable efficient capture of released neutrons during the process, the first and second containers are suspended in an environment 4 capable of absorbing neutrons. This environment is made of material rich in hydrogen and/or material with a high thermal neutron absorption capacity to reduce the energy of neutron flux quickly and capture neutrons in the material itself. A gamma shield 5 made of heavy metal is used to prevent radioactive rays from scattering into the outer environment. An outer metal box 6 holds the complete assembly of the neutron source 1, first container 2, second container 3, neutron absorber 4, and gamma shield 5. The system is provided with a wheel arrangement 7 to open it.

To produce radioisotopes, the neutrons participating in the reaction must have an energy greater than the reaction threshold. For the purposes of producing radioisotopes, neutrons are generated using the following fusion reaction;
D+T---->⁴He+n(Eₙ =14MeV)
where D, T and ⁴He are deuteron, triton and helium respectively. These neutrons are generated in the neutron generator vessel at a high intensity, which is necessary to produce enough radioisotopes for practical use. The neutrons then react according to the (n,2n) reaction with the isotope sample placed in the second container 3 to produce the resultant radioisotope. A neutron absorber 4 and gamma ray absorber 5 are used to absorb the neutrons and gamma rays emitted during the process. For shielding and reducing the harmful effects of radioactive rays, the outer core of the oven comprises a metal box 6 of substantial thickness, along with neutron absorber 4 and gamma ray absorber 5 for added effectiveness.

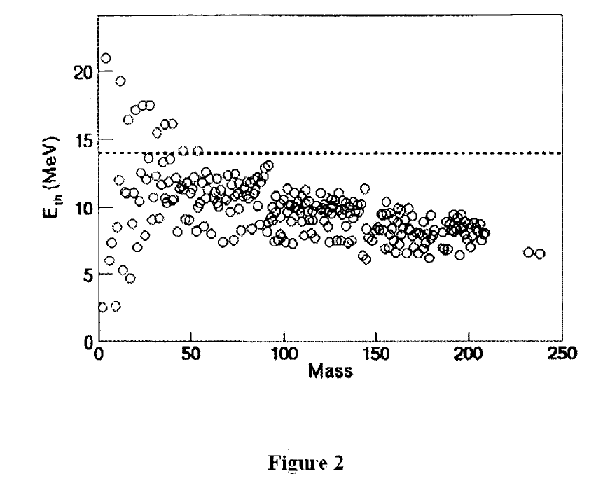

FIG. 2 shows an energy threshold graph of an (n,2n) reaction for stable isotopes. In this figure a dashed line parallel to mass axis shows the energy for 14 MeV neutrons. Most thresholds of stable isotopes lie under this line, indicating that 14 MeV neutrons are able to initiate the reaction to produce other isotopes artificially. It is evident that as the mass of an element increases, the energy required reduces. The threshold energy domain for most of the isotopes is between 7-14 MeV to initiate an (n,2n) reaction to produce other isotopes artificially.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An isotope generator comprising: a first container for hosting a neutron source, and a second container for containing a sample arranged in proximity of said first container for receiving and exposing said sample to the neutrons received from said neutron source, to enable isotope generation, said first and second containers being suspended in an environment capable of absorbing neutrons.

2. An isotope generator as defined in claim 1 wherein said first and second containers are made of one or more light material.

3. An isotope generator as defined in claim 1, wherein said light material being such that it allows penetration of neutrons in at least one direction.

4. An isotope generator as defined in claim 2, wherein said light material includes ceramics, aluminum, or any other light material.

5. An isotope generator as defined in claim 1, wherein said second container is a plurality of containers.

6. An isotope generator as defined in claim 1, wherein said second container is provided with one or more chambers for containing one or more samples.

7. An isotope generator as defined in claim 1, wherein said neutron absorbing environment is encapsulated in a gamma shield.

8. An isotope generator as defined in claim 1, wherein said gamma shield is heavy-metal shield for absorbing gamma rays.

9. An isotope generator as defined in claim 1, further comprises an opening/closing mechanism for allowing access into said isotope generator.

10. An isotope generator as defined in claim 9 wherein said opening/closing mechanism is a door.

11. A method for isotope generation comprising the steps of: providing a first container containing neutron source for emitting neutrons, providing a second container containing a sample arranged in proximity of said first container, providing a means for absorbing excess neutrons of the neutron generator, generating neutron flux from said neutron source, exposing said sample to generated neutron flux, starting a reaction in said sample with neutron flux, liberating more then one neutron from said sample through said reaction and; receiving required isotope from said second container.

12. A method for isotope generation as defined in claim 11, wherein said system is further provided with means for absorbing gamma rays emitted during the reaction.

13. A method for isotope generation as defined in claim 11, wherein said sample is a stable isotope.

14. A method for isotope generation as defined in claim 11, wherein said sample is a long lived isotope.

15. A method for isotope generation as defined in claim 11, wherein said neutron flux energy is higher than the reaction threshold.

16. A method for isotope generation as defined in claim 11, wherein said reaction is an (n,2n) reaction, in that a nucleus of said sample reacts with a neutron of neutron flux and by loosing one neutron produces an isotope with same atomic number and atomic mass reduced by one.

17. A method for isotope generation comprising the steps of; providing a first container containing a neutron source for emitting neutrons; providing a second container containing a sample arranged in the proximity of said first container;
providing a means of absorbing excess neutrons of the neutron generator;
generating neutron flux from said neutron source; exposing said sample to generated neutron flux; starting reaction in said sample with neutron flux;
liberating more than one neutron from said sample through said reaction and receiving an intermediate isotope, and; receiving final isotope on further radiation of a beta ray from said intermediate isotope.

18. A method for isotope generation as defined in claim 17, wherein said system is further provided with means for absorbing gamma rays emitted during the process.

19. A method for isotope generation as defined in claim 17, wherein said sample is a stable isotope.

20. A method for isotope generation as defined in claim 17, wherein said sample is a long lived isotope.

21. A method for isotope generation as defined in claim 17, wherein said neutron flux energy is higher than reaction threshold.

22. A method of isotope generation as defined in claim 17, wherein said activation method consists of an (n,2n) reaction in that the nucleus of said sample reacts with a neutron of neutron flux and in losing one neutron, produces an intermediate isotope, said intermediate isotope upon the further emission of a beta ray, produces an isotope with an atomic number and atomic mass both reduced by one.
